(19) United States
(12) Patent Application Publication
(10) Pub. No.: US 2011/0022467 A1
(43) Pub. Date: Jan. 27, 2011

(54) METHOD OF TARGETED MARKETING

(76) Inventors: Conrad R. Carney, II, Lexington, KY (US); James H. Johnson, JR., Lexington, KY (US)

Correspondence Address: KING & SCHICKLI, PLLC, 247 NORTH BROADWAY, LEXINGTON, KY, 40507, US

(21) Appl. No.: 12/841,398

(22) Filed: Jul. 22, 2010

Related U.S. Application Data
(60) Provisional application No. 61/227,552, filed on Jul. 22, 2009.

(51) Int. Cl. G06Q 30/00; G06Q 90/00; G01S 19/42

(52) U.S. Cl. 705/14.58; 705/500; 342/357.25

(57) ABSTRACT

A method of targeted marketing includes the step of establishing a targeted marketing geographic area for a business. The method further includes the step of determining the location of a subscriber customer. In addition the method includes the step of sending promotional material for the business to the subscriber customer when the subscriber customer is located in the geographic area for targeted marketing.

This application claims priority to U.S. Provisional Patent Application Ser. No. 61/227,552 filed 22 Jul. 2009, the entire disclosure of which is incorporated herein by reference.

### TECHNICAL FIELD AND INDUSTRIAL APPLICABILITY OF THE INVENTION

The present invention relates generally to the marketing field and, more particularly, to a method of marketing utilizing mobile phone text messaging.

### BACKGROUND OF THE INVENTION

The marketing of goods and services by means of mobile phone text messaging is a rapidly growing field. The concept of narrow casting text messages to existing or potential business customers is known. Relevant prior art patents include U.S. Pat. No. 6,754,314 to Wengrovitz et al, U.S. Pat. No. 7,197,324 to Sweeney and U.S. Pat. No. 7,437,413 to Okuyama et al.

The present invention relates to a new and improved method of marketing using a mobile phone text messaging service.

### SUMMARY OF THE INVENTION

The present invention relates generally to a method of targeted marketing comprising the steps of establishing a targeted marketing geographic area for a business, determining location of a subscriber customer and sending promotional material for that business to the subscriber customer when the subscriber customer is located in the targeted marketing geographic area. The method may further include the step of locating the subscriber customer using a global positioning satellite feature of a mobile communication device carried by the subscriber customer.

In accordance with additional aspects of the present invention the method includes matching subscriber customer preferences to a business before sending the promotional material of that business to the subscriber customer. Further, the method may include selecting the target marketing geographic area based upon proximity to a selected commercial location of the business. Alternatively, or in addition, the method may include the step of selecting the target marketing geographic area based upon proximity to a selected location of a competitor to the business. Further, the method may include sending coupons to the subscriber customer in an effort to promote the business.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical block diagram illustrating the relationship between the various entities involved in the target marketing concept of the present invention; and

FIG. 2 is a schematical block diagram illustrating the method of the present invention.

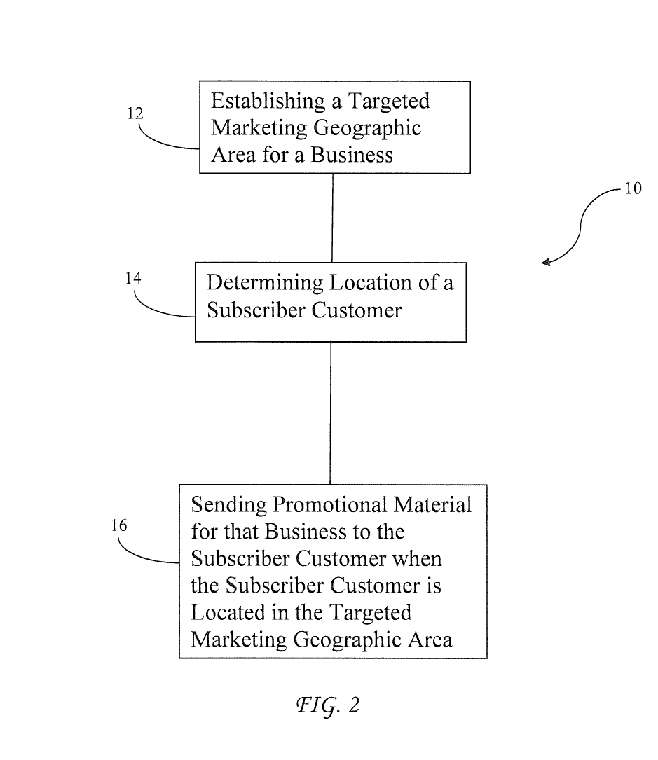

Reference will now be made in detail to the present preferred embodiment of the invention, examples of which are illustrated in the accompanying drawings.

### DETAILED DESCRIPTION OF THE INVENTION

The present invention relates to a method (10) of location specific targeted marketing that may be broadly described as comprising the steps of establishing a targeted marketing geographic area for a business (12), determining the location of a subscriber customer (14) and sending promotional material for the business to the subscriber customer when the subscriber customer is located in the geographic area identified for the targeted marketing (16).

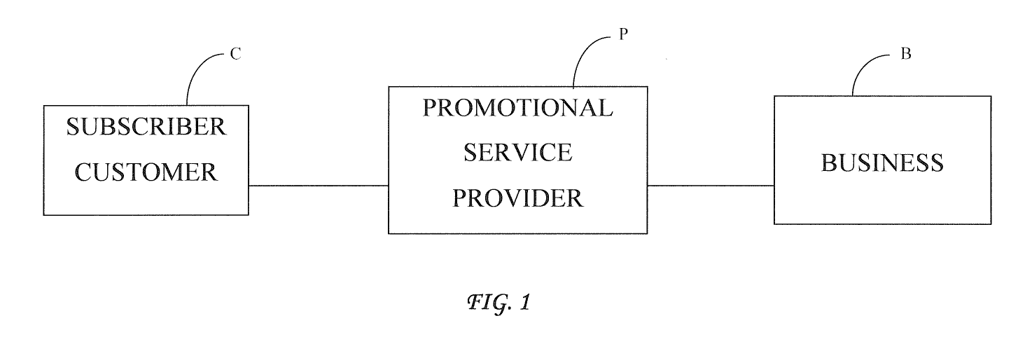

As illustrated in FIG. 1, a promotional service provider P is engaged by a business B to promote the business to subscriber customers C. Toward this end, the promotional service provider P may utilize a mobile phone text messaging service. Such a text messaging service is a permission based service requiring the registration of a customer or potential customer of the business B. Two mediums are provided for a customer C to join or become a subscriber of the text messaging service. The first provides for customer registration via an internet website. The second provides for customer registration via mobile phone texting. Thus, a potential customer or existing customer C may utilize his mobile phone to register via the cell phone registration medium.

In order to register, a customer C provides personal data which is stored in memory by the promotional service provider P. That data includes, but may not necessarily be limited to, residence information including address and mobile phone number. The individual registering may then review a list of businesses represented by the promotional service provider P via the text messaging service. The individual or subscriber customer C then selects those businesses B from which it is desired to receive discounts, coupons and other communication. This activates text messaging services whereby the promotional service provider P provides promotional information of the selected business or businesses B to the subscriber customer C with pre-authorized customer approval.

All business customers C are then maintained on a list by the promotional service provider P. The service provider P may use the system to provide a business B with an indication of how many times a particular individual or customer C has taken advantage of a coupon or special offer sent by text message. Thus, the list represents valuable marketing information stored by the promotional service provider P. This greatly increases the value of the service provided by the promotional service provider P and provides the business B with an incentive to maintain the service.

In accordance with the particular method of the present invention, it should be appreciated that the targeted marketing is location specific: that is, promotional material for the business B is only sent to the subscriber customer C when the subscriber customer is located within a pre-defined geographic area for which the targeted marking program has been designed. The geographic area for targeted marketing may be based upon proximity to a selected commercial location of the business B. Alternatively, the geographic area for targeted marketing may be based upon proximity to a selected location of a competitor to the business B. Further, the geographic area for targeted marketing may, alternatively, be based upon both proximity to the selected commercial location of the business B as well as proximity to a selected location of a competitor to the business.

In accordance with an additional aspect of the present invention, the mobile phone text messaging service provided by the promotional service provider P includes a global positioning satellite monitor. The global positioning satellite, or GPS, monitor locates the individual subscriber customer or potential customer C by monitoring the global positioning satellite or GPS feature of the mobile phone carried by that customer. Once the individual customer reaches an identified or preselected target marketing geographic area, the promotional service provider P sends a communication to the individual customer C specific for the identified target marketing geographic area.

In one particularly useful embodiment of the invention, the promotional service provider P sends promotional material or coupons to the subscriber customer C in an effort to promote the business B when the subscriber customer enters the targeted marketing geographic area. Thus, for example, when the customer C is identified by the global positioning satellite monitor as being within two miles of a retail location of the business, the promotional service provider P sends a discount coupon for a good or service provided by the business. This can, for example, be a very effective way of marketing ice cream on a hot summer day or salt/de-icer on a cold winter day.

In yet another example, the promotional service provider P sends a coupon to a subscriber customer C when the GPS monitor determines that the customer is within a mile of a competitor to the business B. This is done in an effort to lead the customer away from the competitor and to purchase goods or services from the business B instead. Thus, it should be appreciated that the marketing provided by the promotional service provider P is targeted, more efficient and more effective thereby increasing the sales of the business B with the subscriber customers C.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A method of target marketing, comprising:
establishing a targeted marketing geographic area for a business;
determining location of a subscriber customer; and
sending promotional material for said business to said subscriber customer when said subscriber customer is located in said targeted marketing geographic area.

2. The method of claim 1, including locating said subscriber customer using a global positioning satellite feature of a mobile communication device carried by said subscriber customer.

3. The method of claim 1, including matching subscriber customer preferences to a business before sending said promotional material of said business to said subscriber customer.

4. The method of claim 1, including determining location of said subscriber customer by monitoring location of mobile phone of said subscriber customer and sending promotional material to said subscriber customer over said mobile phone.

5. The method of claim 1, including selecting said target marketing geographic area based upon proximity to a selected commercial location of said business.

6. The method of claim 5, including selecting said target marketing geographic area based upon proximity to a selected location of a competitor to said business.

7. The method of claim 1, including selecting said target marketing geographic area based upon proximity to a selected location of a competitor to said business.

8. The method of claim 1, including sending coupons to said subscriber customer in an effort to promote said business.
